(19) United States
(12) Patent Application Publication
(10) Pub. No.: US 2026/0280798 A1
(43) Pub. Date: Sep. 17, 2026

(54) TWO-PART SPARSE SRS CONFIGURATION SIGNALING

(71) Applicant: Samsung Electronics Co., Ltd., Suwon-si (KR)

(72) Inventors: Xinliang Zhang, Plano, TX (US); Young Han Nam, Plano, TX (US); Fan Zhang, Frisco, TX (US)

(21) Appl. No.: 19/558,287

(22) Filed: Mar. 5, 2026

Related U.S. Application Data
(60) Provisional application No. 63/772,249, filed on Mar. 14, 2025.

(51) Int. Cl. H04L 5/00

(52) U.S. Cl. CPC H04L 5/0048

(57) ABSTRACT

A BS includes a processor, and a transceiver operably coupled to the processor. The transceiver is configured to transmit first information indicating a sounding reference signal (SRS) resource configuration for at least one user equipment (UE) operating according to a first radio access technology (RAT), and transmit second information indicating an SRS resource sampling configuration for the at least one UE operating according to the first RAT. The SRS resource configuration allocates, to the at least one UE operating according to the first RAT, one or more SRS resources from an SRS resource set that are different from SRS resources from the SRS resource set allocated to at least one UE operating according to a second RAT.

### CROSS-REFERENCE TO RELATED APPLICATION(S) AND CLAIM OF PRIORITY

This application claims priority under 35 U.S.C. § 119(e) to U.S. Provisional Patent Application No. 63/772,249 filed on Mar. 14, 2025. The above-identified provisional patent application is hereby incorporated by reference in its entirety.

### TECHNICAL FIELD

This disclosure relates generally to wireless networks. More specifically, this disclosure relates to two-part sparse sounding reference signal (SRS) configuration signaling.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveforms (e.g., new radio access technologies [RATs]) to flexibly accommodate various services/applications with different requirements, new multiple access schemes to support massive connections, etc.

### SUMMARY

This disclosure provides apparatuses and methods for two-part sparse SRS configuration signaling.

In one embodiment, a base station (BS) is provided. The BS includes a processor, and a transceiver operably coupled to the processor. The transceiver is configured to transmit first information indicating a sounding reference signal (SRS) resource configuration for at least one user equipment (UE) operating according to a first radio access technology (RAT), and transmits second information indicating an SRS resource sampling configuration for the at least one UE operating according to the first RAT. The SRS resource configuration allocates, to the at least one UE operating according to the first RAT, one or more SRS resources from an SRS resource set that are different from SRS resources from the SRS resource set allocated to at least one UE operating according to a second RAT.

In another embodiment, a UE is provided. The UE includes a processor, and a transceiver operably coupled to the processor. The transceiver is configured to receive first information indicating an SRS resource configuration for the UE operating according to a first radio access technology, and receives second information indicating an SRS resource sampling configuration for the UE operating according to the first RAT. The SRS resource configuration allocates, to the UE operating according to the first RAT, one or more SRS resources from an SRS resource set that are different from SRS resources from the SRS resource set allocated to at least one UE operating according to a second RAT.

In yet another embodiment, a method of operating a BS is provided. The method includes transmitting first information indicating an SRS resource configuration for at least one UE operating according to a first RAT, and transmitting second information indicating an SRS resource sampling configuration for the at least one UE operating according to the first RAT. The SRS resource configuration allocates, to the at least one UE operating according to the first RAT, one or more SRS resources from an SRS resource set that are different from SRS resources from the SRS resource set allocated to at least one UE operating according to a second RAT.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates example antenna beamforming architecture according to embodiments of the present disclosure;

FIG. 5 illustrates an example SRS configuration according to embodiments of the present disclosure;

FIG. 6 illustrates an SRS design comparison according to embodiments of the present disclosure

FIG. 7 illustrates an example of SRS multiplexing among UEs operating according to different RATs according to embodiments of the present disclosure;

FIG. 8 illustrates an example two-part SRS resource configuration according to embodiments of the present disclosure;

FIG. 9 illustrates an example set of time-frequency resources comprised of multiple frequency hopping subbands according to embodiments of the present disclosure;

FIG. 10 illustrates an example set of time-frequency resources comprising multiple comb-offsets according to embodiments of the present disclosure;

FIG. 11 illustrates an example framework of a time-frequency resources configuration according to embodiments of the present disclosure;

FIG. 12 illustrates an example of common comb configuration of a set of time-frequency resources according to embodiments of the present disclosure;

FIG. 13 illustrates an example comb configuration per set of time-frequency resources according to embodiments of the present disclosure;

FIG. 14 illustrates an example direct configuration of a set of time-frequency resource in Part I signaling according to embodiments of the present disclosure;

FIG. 15 illustrates an example set of time-frequency resources comprising multiple frequency hopping subbands, where the SRS resource on each subband comprises different comb-offset combinations according to embodiments of the present disclosure;

FIG. 16 illustrates an example complimentary time-frequency resource configuration in Part I signaling according to embodiments of the present disclosure;

FIG. 17 illustrates an example Part II SRS resource sampling configuration according to embodiments of the present disclosure;

FIG. 18 illustrates an example of an SRS resource subsampling configured in Part II signaling and the time-frequency resource configured in Part I signaling according to embodiments of the present disclosure;

FIGS. 19A-19F illustrate example SRS subsampling patterns according to embodiments of the present disclosure;.

FIG. 20 illustrates an example of a Part II configuration in each Part I configuration according to embodiments of the present disclosure;

FIG. 21 illustrates example of coupling Part I and Part II configurations according to embodiments of the present disclosure;

FIG. 22 illustrates an example AI-based SRS inpainting framework according to embodiments of the present disclosure;

FIG. 23 illustrates an example method for two-part sparse SRS configuration signaling according to embodiments of the present disclosure; and

FIG. 24 illustrates another example method for two-part sparse SRS configuration signaling according to embodiments of the present disclosure

### DETAILED DESCRIPTION

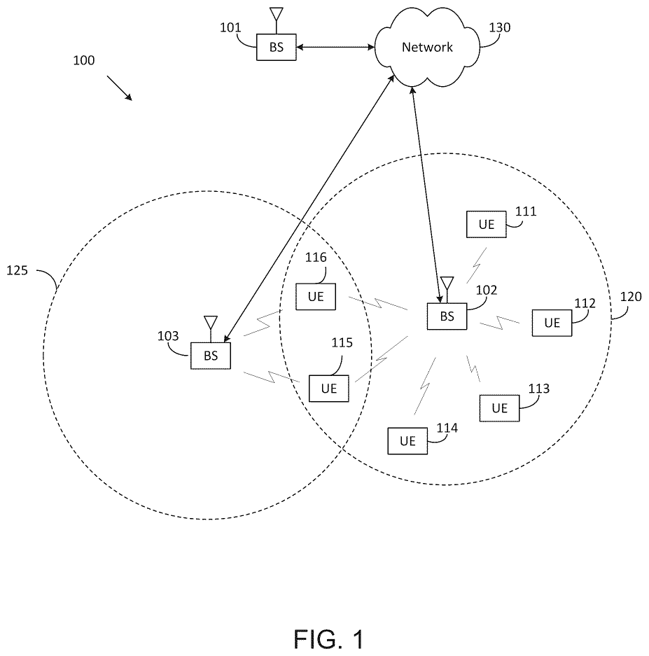

FIGS. 1 through 24, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for two-part sparse SRS configuration signaling. In certain embodiments, one or more of the gNBs 101-103 includes circuitry, programing, or a combination thereof, to support two-part sparse SRS configuration signaling in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

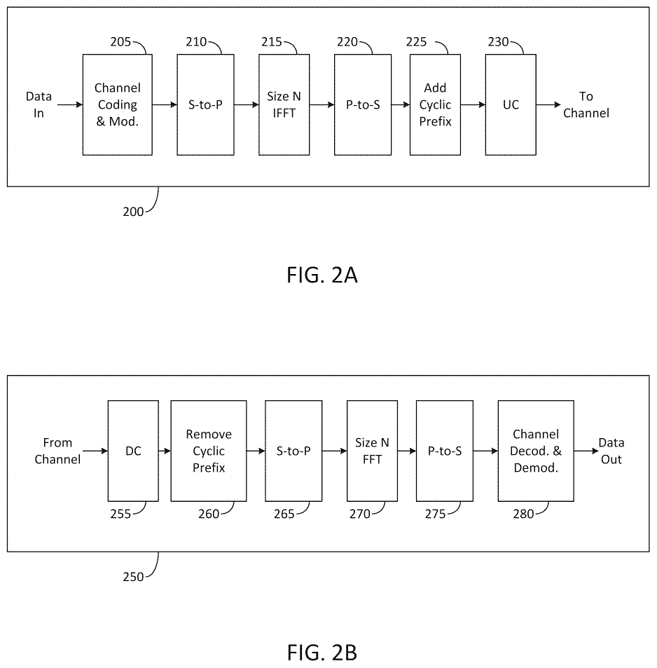

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support two-part sparse SRS configuration signaling as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

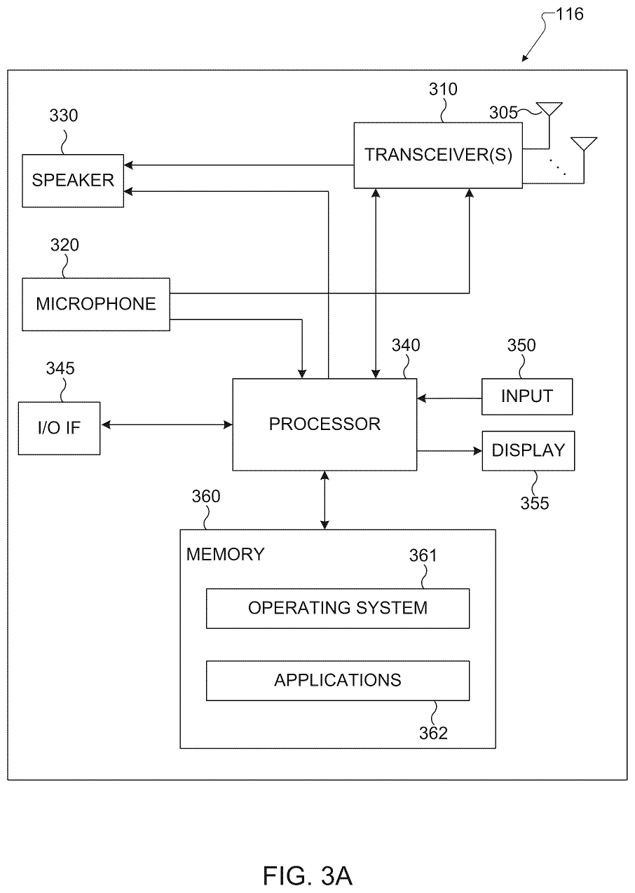

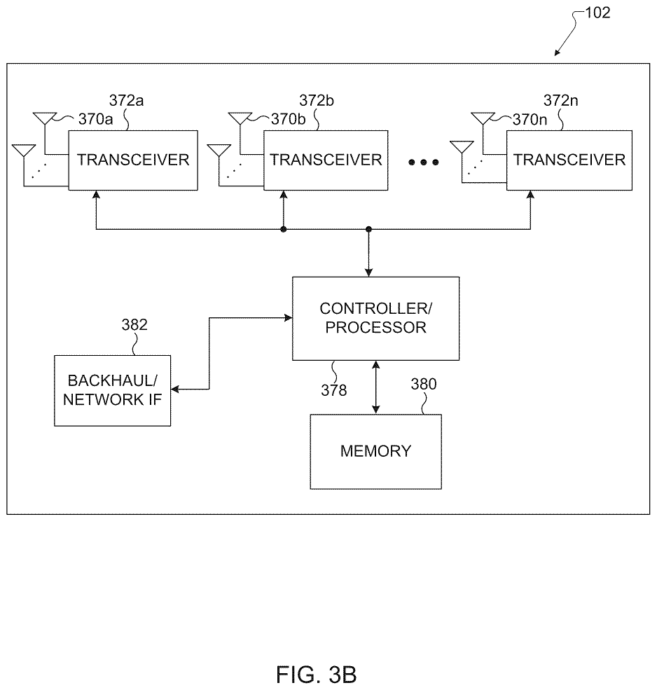

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for two-part sparse SRS configuration signaling as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support two-part sparse SRS configuration signaling as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

Rel. 13 LTE supports up to 16 CSI-RS antenna ports which enable a gNB to be equipped with a large number of antenna elements (such as 64 or 128). In this case, a plurality of antenna elements is mapped onto one CSI-RS port. Furthermore, up to 32 CSI-RS ports will be supported in Rel. 14 LTE. For next generation cellular systems such as 5G, it is expected that the maximum number of CSI-RS ports will remain more or less the same.

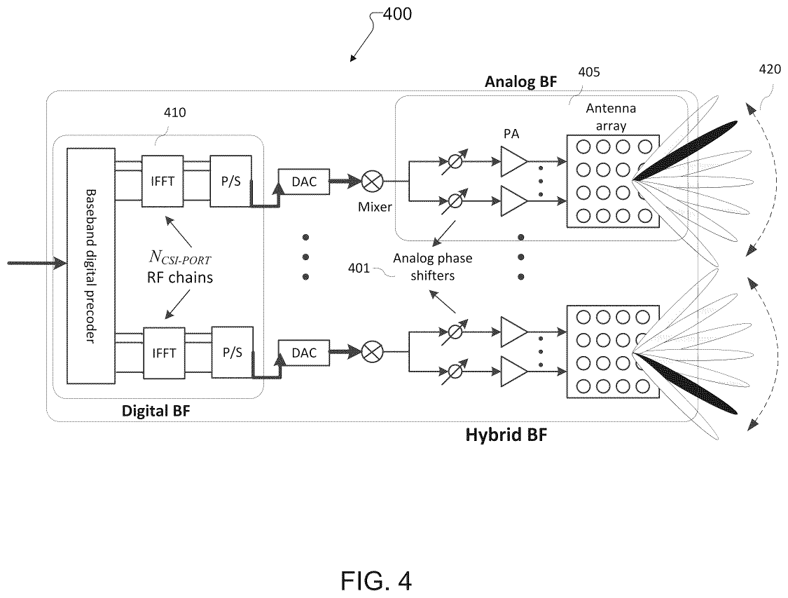

For mmWave bands, although the number of antenna elements can be larger for a given form factor, the number of CSI-RS ports-which can correspond to the number of digitally precoded ports-tends to be limited due to hardware constraints (such as the feasibility to install a large number of ADCs/DACs at mmWave frequencies) as illustrated by beamforming architecture 400 in FIG. 4.

FIG. 4 illustrates example antenna beamforming architecture 400 according to embodiments of the present disclosure. The embodiment of the antenna beamforming architecture illustrated in FIG. 4 is for illustration only. Different embodiments of an antenna beamforming architecture could be used without departing from the scope of this disclosure.

In the example of FIG. 4, one CSI-RS port is mapped onto a large number of antenna elements which can be controlled by a bank of analog phase shifters 401. One CSI-RS port can then correspond to one sub-array which produces a narrow analog beam through analog beamforming 405. This analog beam can be configured to sweep across a wider range of angles 420 by varying the phase shifter bank across symbols or subframes or slots (wherein a subframe or a slot comprises a collection of symbols and/or can comprise a transmission time interval). The number of sub-arrays (equal to the number of RF chains) is the same as the number of CSI-RS ports N_{CSI-PORT}. A digital beamforming unit 410 performs a linear combination across N_{CSI-PORT} analog beams to further increase precoding gain. While analog beams are wideband (hence not frequency-selective), digital precoding can be varied across frequency sub-bands or resource blocks.

Although FIG. 4 illustrates one example antenna beamforming architecture 400, various changes may be made to FIG. 4. For example, various components in FIG. 4 could be combined, further subdivided, or omitted and additional components could be added according to particular needs.

In networks operating according to existing or future radio access technologies (RATs) such as 5G New Radio (NR) or 6G, Channel State Information Reference Signals (CSI-RSs) are used to measure the channel quality and enable accurate channel estimation, beamforming, and link adaptation. However, the transmission of CSI-RS incurs significant overhead, which can lead to reduced spectral efficiency and increased latency.

In 5G New Radio (NR), the Sounding Reference Signal (SRS) plays a critical role in uplink (UL) communication, enabling the network to assess the channel quality and perform advanced operations like channel estimation, beam management, and scheduling. The SRS is highly configurable to meet diverse use cases, thanks to the SRS's flexibility in both the time and frequency domains.

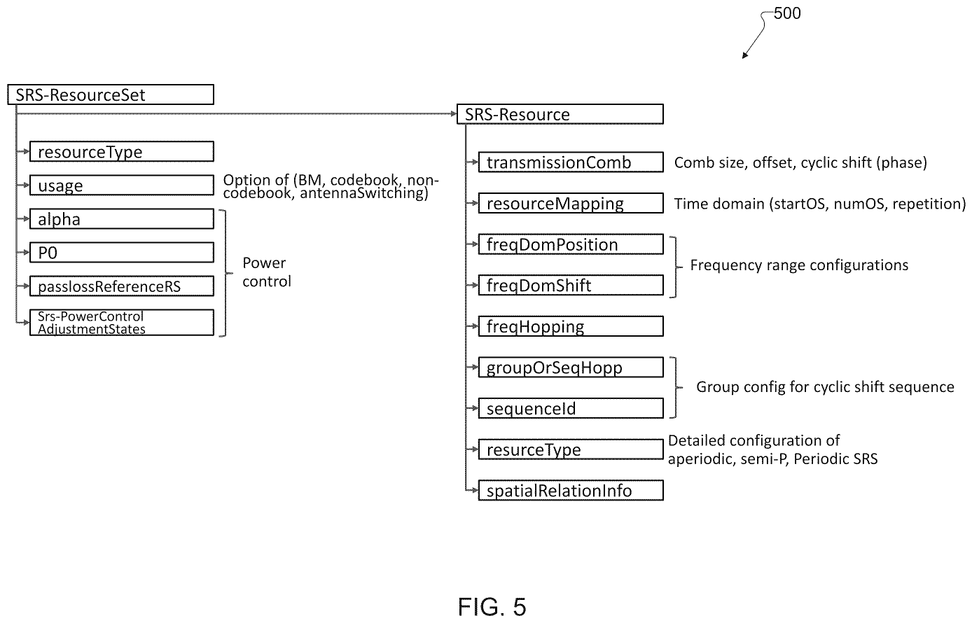

The configuration of the SRS in 5G NR is managed through the RRC (Radio Resource Control) layer, where the configuration is organized into two main components: SRS-ResourceSet and SRS-Resource, as illustrated in FIG. 5.

FIG. 5 illustrates an example SRS configuration 500 according to embodiments of the present disclosure. The embodiment of an SRS configuration of FIG. 5 is for illustration only. Different embodiments of an SRS configuration could be used without departing from the scope of this disclosure.

In the example of FIG. 5, SRS-ResourceSet defines the broader group of resources. Key parameters of SRS-ResourceSet include:
resourceType: Configurations such as Aperiodic (AP), Semi-Persistent (semi-P), and Periodic SRS transmissions.
usage: Supports multiple functionalities, including beam management, codebook-based transmissions, non-codebook usage, and antenna switching.
Power Control: Managed through parameters like alpha, P0, and passlossReferenceRS, with additional control via Srs-PowerControlAdjustmentStates.

SRS-Resource specifies detailed characteristics of each SRS resource. Core parameters of SRS-Resource include:
transmissionComb: Configures comb size, offset, and cyclic shift (phase) to facilitate efficient resource allocation.
resourceMapping: Controls time domain aspects such as the start symbol, number of symbols, and repetition factor.
freqDomPosition and freqDomShift: Define the frequency domain position and shifts within the bandwidth part (BWP).
freqHopping: Allows frequency hopping configurations across resource blocks (RBs).
groupOrSeqHopp and sequenceId: Enable group and sequence-based cyclic shift configurations.
resourceType: Mirrors the periodicity and offset options found in the SRS-ResourceSet.
spatialRelationInfo: Supports spatial relationships for beam-based SRS transmission.

Although FIG. 5 illustrates one example SRS configuration 500, various changes may be made to FIG. 5. For example, additional configuration parameters could be included, one or more of the configuration parameters may be excluded, etc. according to particular needs.

The robust configuration framework illustrated in FIG. 5 allows the SRS to adapt to varying network conditions, bandwidth allocations, and antenna schemes, enabling 5G NR to deliver enhanced performance in UL coverage, beamforming, and resource management.

SRS is efficient for network-side Channel State Information (CSI) acquisition, however, its usage by the network is limited due to the delicate balance among several factors:
There's a trade-off between sounding bandwidth and channel aging, where increased sounding bandwidth, although beneficial for CSI accuracy, also exacerbates channel aging effects.
The capacity and overhead of Reference Signals (RSs) pose a constraint, particularly for UE-specific RS, which consume valuable network resources.
The accuracy of CSI is also influenced by UE power limits and aliasing effects. In 5G New Radio (NR), these challenges are further amplified by the introduction of millimeter wave (mmWave) frequencies, massive Multiple-Input Multiple-Output (MIMO), and ultra-reliable low-latency communication (URLLC) use cases, which demand even more accurate and timely CSI.

Therefore, innovative SRS design and optimization techniques are essential to strike a balance between these competing factors and unlock the full potential of 5G NR networks.

One potential solution is one-shot full-band sounding with non-uniform SRS, which encompasses three key components: 1) full band sounding in one-shot (e.g., in one OFDM symbol) with non-uniform sub-sampling, 2) UE power boosting for coverage extension, and 3) network (NW) configured orthogonal non-uniform (e.g., pseudo-random) sub-sampling for RS multiplexing and aliasing reduction. These elements work together to optimize resource allocation, enhance signal quality, and improve overall network performance. By leveraging non-uniform sub-sampling, the system achieves comprehensive frequency domain characterization in a single operation, reducing overhead and optimizing resource allocation. Additionally, UE power boosting dynamically adjusts transmission power to enhance signal strength and coverage area, while orthogonal non-uniform sub-sampling patterns mitigate aliasing effects and enable efficient multiplexing of RSs, thereby enhancing system capacity and spectral efficiency.

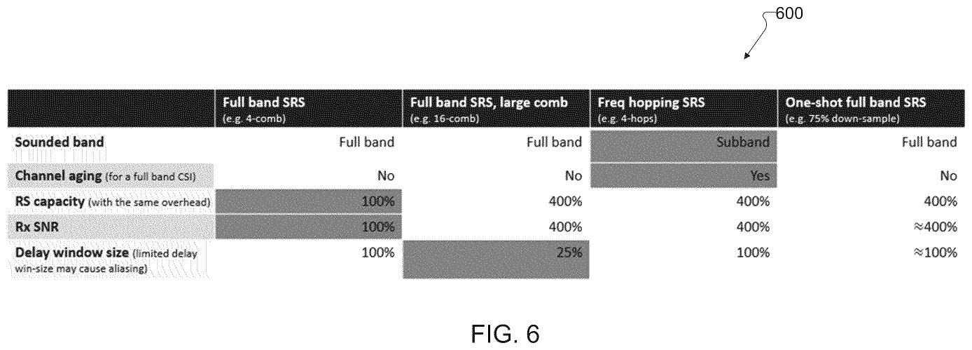

A comparison of one-shot full-band SRS with other alternatives in 5G NR or simple extensions from 5G NR is shown in FIG. 6.

FIG. 6 illustrates an SRS design comparison 600 according to embodiments of the present disclosure. The embodiment of SRS designs of FIG. 6 are for illustration only. Different embodiments of SRS designs could be used without departing from the scope of this disclosure.

In the example of FIG. 6, one-shot full-band SRS is compared against full band SRS (e.g., 4-comb), full band SRS with a large comb (e.g., 16-comb), and frequency hopping SRS (e.g., 4-hops).

As can be seen in FIG. 6, one-shot full band SRS reaches an improved balance on all of the key aspects for UL channel sounding.

Although FIG. 6 illustrates one SRS design comparison 600, various changes may be made to FIG. 6. For example, various changes to the SRS designs could be made, etc., according to particular needs.

Currently existing RATs, such as 5G NR, do not support non-uniform frequency sampling. To provide for reconstructed full band SRS accuracy (for example, for full band reconstruction via CSI inpainting, similar as described by U.S. application Ser. No. 19/232,842, which is hereby incorporated by reference in its entirety), future RATs may benefit from new signaling. For example, a wider sounding band and granular frequency samples may be beneficial for UEs operating according to a future RAT (e.g., 6G) with sparse non-uniform sampling.

To ensure the coexistence of multiple RATs (for example, a future RAT (e.g., 6G) and an existing RAT (e.g., 5G)) in the same cell and same band, an SRS resource for a UE operating according to a first RAT (e.g., 6G) should not interfere with an SRS resource a UE operating according to a second RAT (e.g., 5G).

Various embodiments of the present disclosure provide mechanisms for a UE operating according to a first RAT (e.g., 6G) to provide sparse non-uniform sampling for SRS without interference with SRS resources of a UE operating according to a second RAT (e.g., 5G).

In some embodiments, a UE (for example, a UE operating according to a future RAT) may be configured with one or two set(s) of parameters to identify resource elements (REs) to transmit SRS in an SRS transmission instance. In embodiments such as these, the first set of parameters is configured for the UE to identify a set of time-frequency resources at each SRS transmission instance. This set of parameters may be referred to herein as “Part I” of an SRS configuration signal. If configured, the second set of parameters is configured to identify an RE subsampling pattern within the set of time frequency resources to transmit SRS at the SRS transmission instance. This set of parameters may be referred to herein as “Part II” of the SRS configuration signal. In some embodiments, if the second set of parameters is not configured, the time-frequency resource identified by Part I is used for SRS transmission.

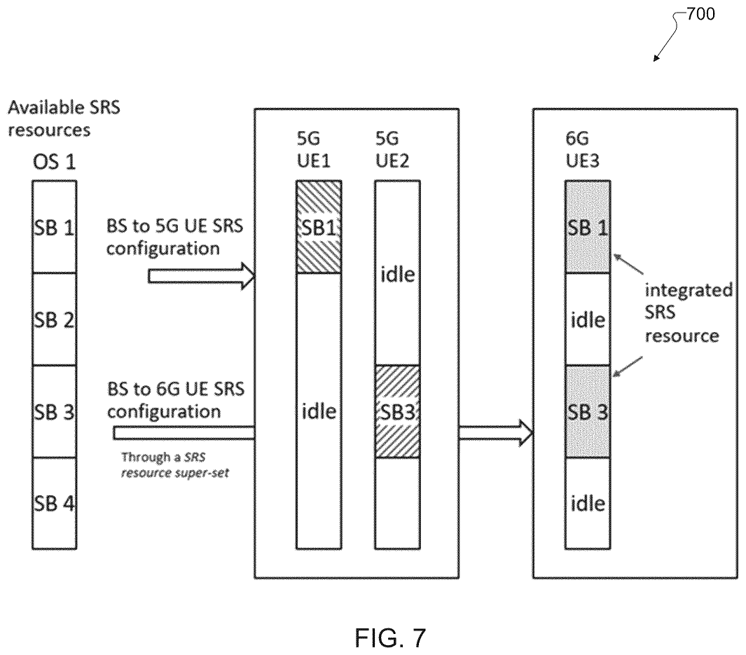

FIG. 7 illustrates an example of SRS multiplexing among UEs operating according to different RATs 700 according to embodiments of the present disclosure. The embodiment of SRS multiplexing of FIG. 7 is for illustration only. Different embodiments of SRS multiplexing among UEs operating according to different RATs could be used without departing from the scope of this disclosure.

In the example of FIG. 7, a BS configures a set of SRS time-frequency resources for an SRS transmission instance among three UEs. For example, in some embodiments, the SRS time-frequency resources may be configured via Part I of an SRS configuration signal. Two of four frequency hopping subbands (SBs) are assigned to a UE (UE3) operating according to a 6G RAT. The remaining two frequency hopping SBs are assigned to two UEs (UE1 and UE2) operating according to a 5G RAT, each of UE1 and UE2 assigned with one SB.

Although FIG. 7 illustrates one example of SRS multiplexing among UEs operating according to different RATs 700, various changes may be made to FIG. 7. For example, various changes to the RATs could be made, the number of UEs could be different, etc. according to particular needs.

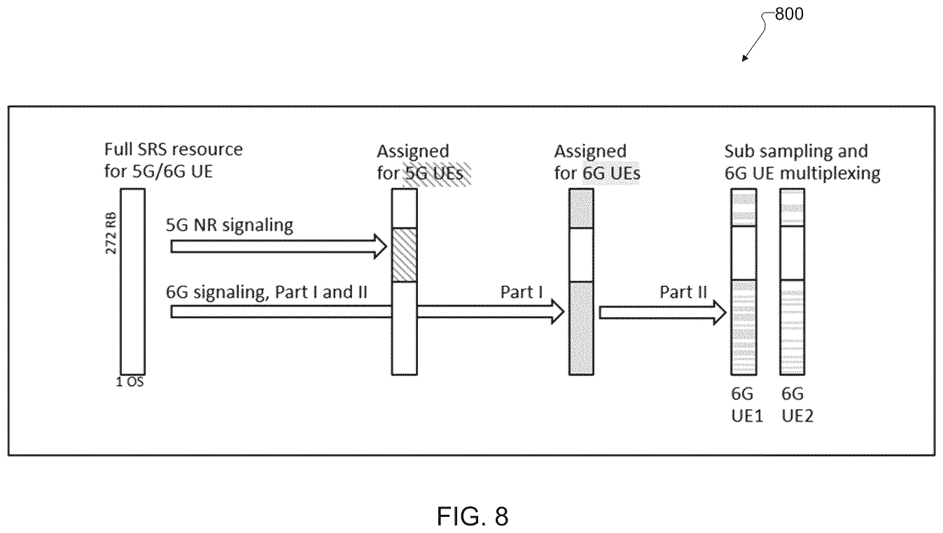

FIG. 8 illustrates an example two-part SRS resource configuration 800 according to embodiments of the present disclosure. The embodiment of a two-part SRS resource configuration of FIG. 8 is for illustration only. Different embodiments of a two-part SRS resource configuration could be used without departing from the scope of this disclosure.

In the example of FIG. 8, a BS configures 5G and 6G UE SRS resources in different frequency subbands. For 6G UE signaling, the available resources (e.g., multiple subbands, combs, comb offsets, etc.) are indicated in the Part I signaling. The Part II signaling indicates the sub-sampling configuration on all of the SRS resources indicated in the Part I signaling. Each 6G UE is then configured with a specific SRS resource for one-shot full band (or certain band) channel sounding.

Although FIG. 8 illustrates one example two-part SRS resource configuration 800, various changes may be made to FIG. 8. For example, various changes to the RATs could be made, the number of UEs could be different, etc. according to particular needs.

In some embodiments, the Part I parameters are used for the UE to identify one or multiple SB(s) for each SRS transmission instance.

In some embodiments, the Part I parameters specify information on a (1) total SRS BW size; (2) subband size; (3) number of SBs; and (4) one or more configured indices. In embodiments such as these, for each SRS transmission instance, an SB index is determined by utilizing at least part of the following information: (1) number of SBs; (2) a configured index; and (3) a band hopping sequence number. If hopping is not configured the SB index is the same as the configured index. If hopping is configured the SB index is determined all the information. When the UE is configured with multiple configured indices, the UE identifies multiple SB indices for the SRS transmission instance. The Part I parameters can comprise a first information on subband partition for the total SRS BW, (e.g., a number of subbands and subband size), and a second information on a list of such subbands to be selected for an SRS band hopping sequence number (analogous to nSRS in 5G NR) if SRS hopping is configured. In some embodiments, the second information is a list of index values (analogous to nRRC in 5G NR), each of which will be used to determine to a subband index together with nSRS.

Alternatively, in some embodiments, the Part I parameters specify one or more combinations of the following information: (1) total SRS BW size; (2) subband size; (3) number of SBs; (4) a configured index. In embodiments such as these, the Part I parameters can comprise one or multiples sets of parameters, wherein each set of parameters specifies a SB when processed together with an SRS band hopping sequence number. Each set of parameters comprise at least one of subband size, number of subbands in the configured BWP or system bandwidth, or parameters to derive subband size and/or the number of subbands, and one index.

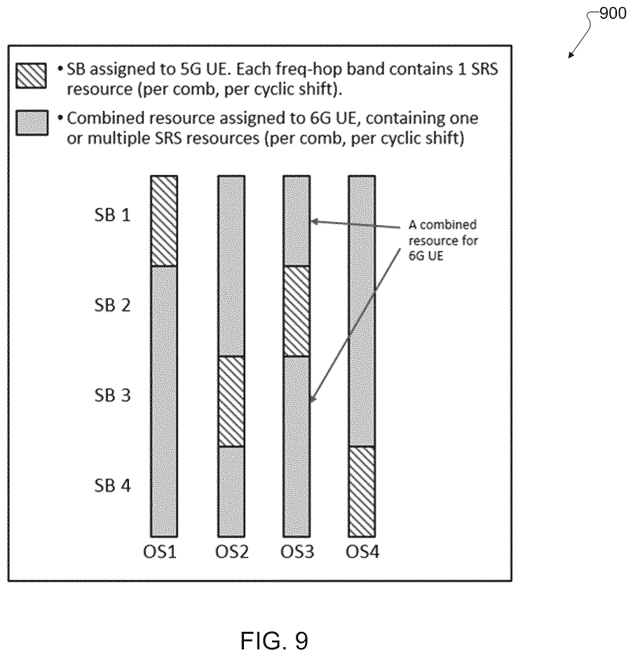

FIG. 9 illustrates an example set of time-frequency resources comprised of multiple frequency hopping subbands 900 according to embodiments of the present disclosure. The embodiment of time-frequency resources comprised of multiple frequency hopping subbands of FIG. 9 is for illustration only. Different embodiments of time-frequency resources comprised of multiple frequency hopping subbands without departing from the scope of this disclosure.

In the example of FIG. 9, SRS SBs are identified by a UE based on Part I signaling. The Part I signaling indicates to the UE that the number of SBs is 4, and the configured indices are {1, 2, 3}. Four one-shots (Oss) illustrated in FIG. 9 correspond to the four band hopping sequence numbers, {0, 1, 2, 3}. For each OS (for a given subband hoping sequence number), the UE identifies a corresponding SB for each configured index. For these 3 configured indices, the UE identifies 3 SBs per OS, which is a superset of time-frequency resources to transmit an SRS.

Although FIG. 9 illustrates one of time-frequency resources comprised of multiple frequency hopping subbands 900, various changes may be made to FIG. 9. For example, various changes to the RATs could be made, the number of UEs could be different, etc. according to particular needs.

In some embodiments, the Part I parameters specify information on (1) the comb size; and (2) the use one or more comb offsets. I embodiments such as these, for each SRS transmission instance, a comb size determines the comb structure on the SB for SRS transmission. The comb-offset(s) identify which of the one or more comb-offsets the SRS transmission is on for the specific comb size value.

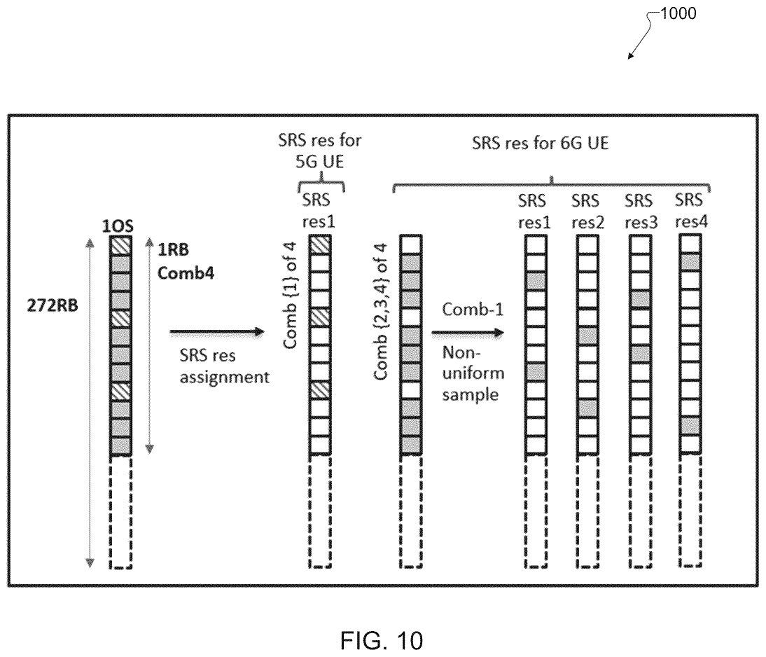

FIG. 10 illustrates an example set of time-frequency resources comprising multiple comb-offsets 1000 according to embodiments of the present disclosure. The embodiment of time-frequency resources of FIG. 10 is for illustration only. Different embodiments of a set of time-frequency resources comprising multiple comb-offsets could be used without departing from the scope of this disclosure.

In the example of FIG. 10, SRS comb-offsets with a specific comb size are identified by a UE based on Part I signaling.

In the example of FIG. 10, the BS configures 1 SRS resource with comb-4 and comb offset 0 to a 5G UE. The BS configures the rest of the SRS resources (three comb-4 SRS resources with comb offset {1, 2, 3}) as one resource to 6G UEs in a set of time-frequency resources. Four of the SRS resources for 6G UEs are configured with comb-1, non-uniformly sampled from the set of time-frequency resources.

Although FIG. 10 illustrates one example set of time-frequency resources comprising multiple comb-offsets 1000, various changes may be made to FIG. 10. For example, various changes to the RATs could be made, the number of UEs could be different, etc. according to particular needs.

In some embodiments, a BS allocates UEs operating according to a future RAT (e.g., 6G) with one or multiple (e.g., in a list) set(s) of time-frequency resources. In embodiments such as these, each time-frequency resource can include:
An indicator: for the BS and UE to identify the specific time-frequency resource configuration.
A frequency domain resource configuration: a common frequency domain configuration to all the SRS resource sets in the list, to configure the cell ID, band width part (BWP), etc.
A time domain resource configuration: a common time domain configuration to all the SRS resource sets in the list, to configure the periodic configuration, slot configuration, OFDM symbol configuration.
A list of SRS resource sets: includes one or multiple non-repeated hopping subbands of a specific hopping pattern, one or multiple non-repeated comb offsets of a specific comb size (associated to the off-set list), that not assigned to UEs operating according to an existing RAT (e.g.5G).

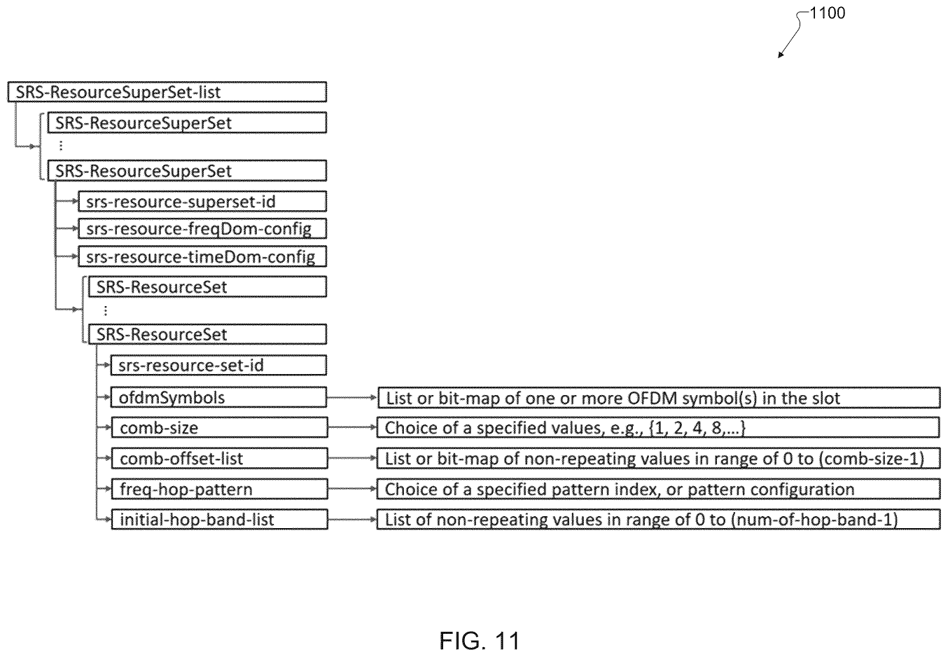

FIG. 11 illustrates an example framework of a time-frequency resources configuration 1100 according to embodiments of the present disclosure. The embodiment of a framework of a time-frequency resources configuration of FIG. 11 is for illustration only. Different embodiments of a framework of a time-frequency resources configuration could be used without departing from the scope of this disclosure.

In the example of FIG. 11, a hierarchal relationship among SRS resource super-sets, SRS resource sets, the basic aspects of SRS resource, and the configured value or list of values of each basic aspect of SRS resource is shown.

In the example of FIG. 11, the framework includes the following elements:
SRS resource super-set-list: A list of information elements of SRS resource super-sets.
SRS resource super-set: comprises one or more SRS resource sets.
SRS resource set: comprises resource elements corresponding to a number of comb-offsets within a set of subbands within a set of OFDM symbols.

Although FIG. 11 illustrates one example framework of a time-frequency resources configuration 1100, various changes may be made to FIG. 11. For example, various changes to resource sets could be made, etc., according to particular needs.

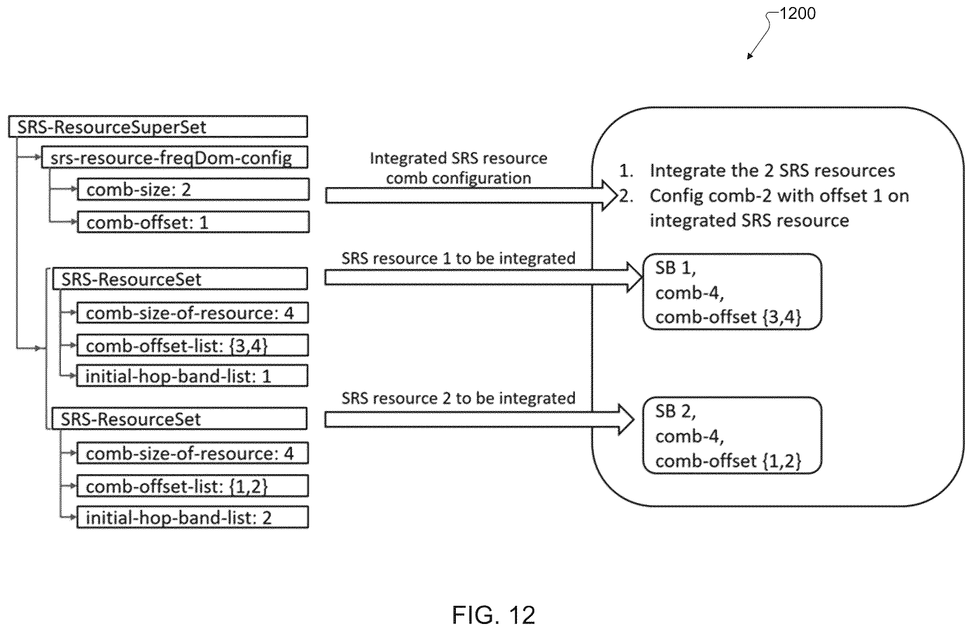

In some embodiments, there can be two types of comb configurations:
One pair of comb size and comb offset list in the SRS resource set configuration indicates a set of time-frequency resources.
The other pair of comb size and comb offset indicates how the set of time-frequency resources is multiplexed by comb.
FIG. 12 illustrates an example of common comb configuration of a set of time-frequency resources 1200 according to embodiments of the present disclosure. The embodiment of common comb configuration of a set of time-frequency resources of FIG. 12 is for illustration only. Different embodiments of common comb configuration of a set of time-frequency resources could be used without departing from the scope of this disclosure.

In the example of FIG. 12, two types of comb size with comb offset(s) are configured in the SRS resource super-set and SRS resource set. One is comprised in the frequency domain resource configuration, indicating the comb size of the set of time-frequency resources, common for all SRS resource indicated by the SRS resource sets. The other is comprised in each of the SRS resource sets, indicating the comb of the set of time-frequency resources.

Although FIG. 12 illustrates one example of common comb configuration of a set of time-frequency resources 1200, various changes may be made to FIG. 12. For example, various changes to offsets could be made, etc., according to particular needs.

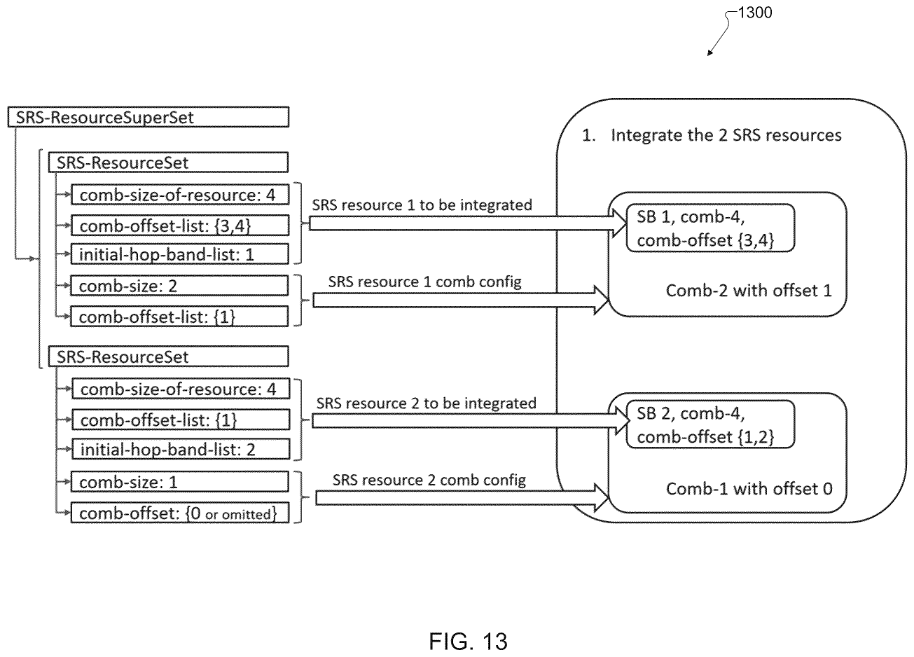

FIG. 13 illustrates an example comb configuration per set of time-frequency resources 1300 according to embodiments of the present disclosure. The embodiment of comb configuration per set of time-frequency resources of FIG. 13 is for illustration only. Different embodiments of a comb configuration per set of time-frequency resources could be used without departing from the scope of this disclosure.

In the example of FIG. 13, two types of comb size with comb offset(s) are both configured in the SRS resource set. One is comprised in the frequency domain resource configuration, indicating the comb size of the set of time-frequency resources, for each SRS resource indicated by the SRS resource sets. The other is comprised in each of the SRS resource sets, indicating the comb of the set of time-frequency resources.

Although FIG. 13 illustrates one example comb configuration per set of time-frequency resources 1300, various changes may be made to FIG. 13. For example, various changes to offsets could be made, etc., according to particular needs.

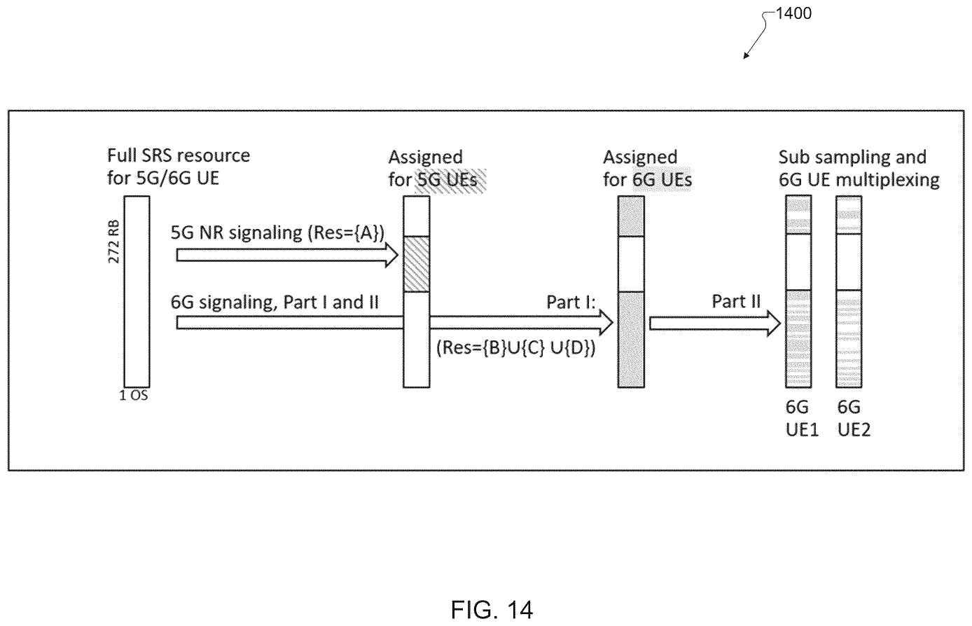

In some embodiments, for example similar as shown in FIG. 14, a BS may directly configure one or more set(s) of time-frequency resources to a UE operating according to a future RAT (e.g., 6G). In embodiments such as these, each set of time-frequency resources includes one or multiple existing RAT (e.g., 5G) style SRS resources.

FIG. 14 illustrates an example direct configuration of a set of time-frequency resource in Part I signaling 1400 according to embodiments of the present disclosure. The embodiment of direct configuration of a set of time-frequency resource in Part I signaling of FIG. 14 is for illustration only. Different embodiments of a direct configuration of a set of time-frequency resource in Part I signaling could be used without departing from the scope of this disclosure.

In the example of FIG. 14, which is a high-level conceptual example of direct configuration of a set of time-frequency resource in Part I signaling, it is assumed that:
the available SRS resources are {A}, {B}, {C}, {D} at the BS side;
the SRS resource configured to the 5G UEs is {A}; and
the set of time-frequency resources configured to the 6G UEs is {B}∪{C}∪{D}, which is configured through Part I.

In Part II, the set of time-frequency resources is further sub-sampled for individual UE sub sampling and multiplexing.

In some embodiments, the SRS resources {A}, {B}, {C}, {D} may be a commonly configured frequency hopping SB 1 and comb size 4, and may be respectively respectively configured with a comb offset as 0, 1, 2, 3. In embodiments such as these, the set of time-frequency resources {B}∪{C}∪{D} can be configured frequency hopping SB 1 and comb size 4, and all REs on comb offset 1 and 2 and 3.

In some embodiments, one time-frequency resource can contain one or multiple SRS resources sets, and can indicate a set of time-frequency resources among all time and frequency resources comprised by all of the SRS resource sets.

In some embodiments, each SRS resource set can configure time and frequency resources on all SBs and comb offsets including:
one or multiple SB(s) of a specific frequency hopping pattern, and
one or multiple comb offset(s) of a specific comb size.

Although FIG. 14 illustrates one example direct configuration of a set of time-frequency resource in Part I signaling 1400, various changes may be made to FIG. 14. For example, various changes to the RATs could be made, the number of UEs could be different, etc. according to particular needs.

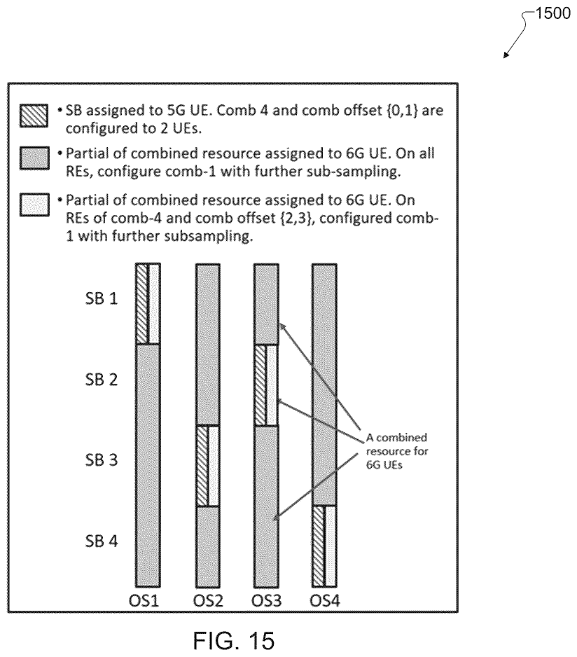

In some embodiments, a BS may configure UEs operating according to different RATs in the same frequency and same OSs, similar as shown in FIG. 15.

FIG. 15 illustrates an example set of time-frequency resources comprising multiple frequency hopping subbands, where the SRS resource on each subband comprises different comb-offset combinations 1500 according to embodiments of the present disclosure. The embodiment of time-frequency resources of FIG. 15 is for illustration only. Different embodiments of time-frequency resources could be used without departing from the scope of this disclosure.

In the example of FIG. 15, a BS configures both 5G and 6G UEs in the same frequency band and the same 4 OSs. The 4 OSs, named OS1 to OS4, are from one slot or multiple slots. The BS configures 5G UE frequency hopping in one or multiple SBs as used in 5G NR, and with comb-N and a partial of the comb offset from {0, . . . , N-1}. The BS configures the resources that have not been configured to 5G UEs through a set of time-frequency resources, then the BS multiplexes the 6G SRS resources to 6G UEs. In FIG. 15, the SB {1, 3, 2, 4} are configured to 5G UEs on OS {1, 2, 3, 4}. For each SB, the 5G SRS resources are configured with comb-4, and comb offset {0, 1} are configured to two 5G UEs. The BS configures the other resources to 6G UEs. These resources include two parts. One part (named part A in this example) includes the SBs in a set of time-frequency resources that not configured to 5G UEs. The other part (named part B in this example) includes the SBs configured to the 5G UEs, but where the comb offset is not used for the 5G UEs. In this example, the BS configures one set of 6G SRS resources, where the part A is configured with comb-1, and the part B is configured with comb-1 on the comb-4 SRS resources with comb offset {2,3}, since the other comb offsets are configured to 5G UEs. The set of time-frequency resources includes part A and part B. In some embodiments, SRS resource sub-sampling is further configured on top of the set of time-frequency resources to support more than four 6G UE multiplexing.

Although FIG. 15 illustrates one example set of time-frequency resources comprising multiple frequency hopping subbands, where the SRS resource on each subband comprises different comb-offset combinations 1500, various changes may be made to FIG. 15. For example, various changes to the RATs could be made, the number of UEs could be different, etc. according to particular needs.

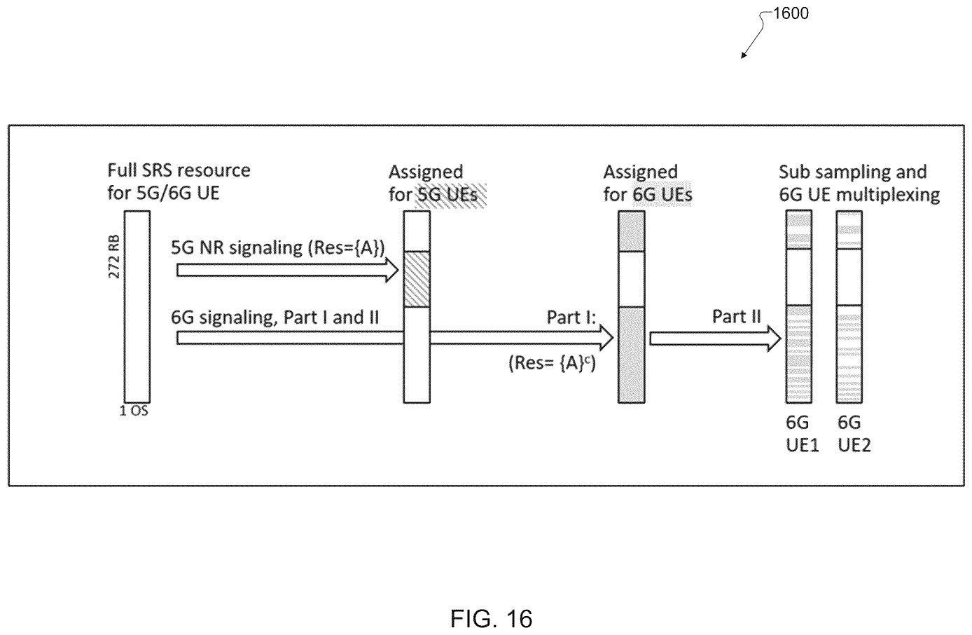

In some embodiments, for example similar as shown in FIG. 16, a BS may configure a complementary resource in a set of time-frequency resources. In embodiments such as these, he resources indicated in the configuration signaling are, for example, used by a UE operating according to an existing RAT (e.g., 5g), or designed to be idle, or for other use. A UE operating according to a future RAT (e.g., 6G) should send SRS on the complementary resource to what is configured the Part I signaling within the frequency band and time configuration (for example, OS(s) configured by the Part I signaling).

FIG. 16 illustrates an example complimentary time-frequency resource configuration in Part I signaling 1600 according to embodiments of the present disclosure. The embodiment of complimentary time-frequency resource configuration in Part I signaling of FIG. 16 is for illustration only. Different embodiments of complimentary time-frequency resource configuration in Part I signaling could be used without departing from the scope of this disclosure.

In the example of FIG. 16, which is a high-level conceptual example of complimentary time-frequency resource configuration in Part I signaling, it is assumed that:
the universal SRS resources set is U={{A}, {B}, {C}, {D}} at the BS side, to a specific configuration of frequency band, OS, etc.;
the SRS resource configured to the 5G UE is {A}; and
the set of time-frequency resources to the 6G UE is the complimentary resource of {A} towards the universal resource set through Part I (i.e., in math expression as {A}c or U\{A}), which equally means a set of multiple time-frequency resource {B}∪{C}∪{D}.

In Part II, the set of time-frequency resources is further sub-sampled for individual UE and multiplexing.

In some embodiments, the universal SRS resources{A}, {B}, {C}, {D} may be commonly configured frequency hopping SB 1 and comb size 4, and are respectively configured with comb offset as 0, 1, 2, 3. In embodiments such as these, the set of multiple time-frequency resource {B}∪{C}∪{D} can be configured frequency hopping SB 1 and comb size 4, and all REs on comb offset 1 and 2 and 3. Under these circumstances, {A}^{c} or U\{A} is just {B}∪{C}∪{D}, i.e., frequency hopping SB 1 and comb size 4, and all REs on comb offset 1 and 2 and 3.

For example, the BS can configure comb-4 SRS resources to both 5G and 6G UEs on the same band and the same OS. The BS can then configure comb offset list {1, 3} to one 5G UE. For 6G UEs, the BS can configure comb offset {1, 3} as a complementary SRS resource. The 6G UEs are configured to transmit SRS on the same frequency band and the same OS to the 5G UE, but are configured on a set of time-frequency resources including all three comb offsets {0, 2} which is complementary to the comb offset {1, 3} list.

In another example, the BS can configure SRS resources in four SBs hopping to both 5G and 6G UEs on the same band and the same OSs. The BS can then configure an initial SB index, for example the frequency domain position n_RRC in 5G NR as {0} for starting at the first SB to one 5G UE. For 6G UEs, the BS can configure n_RRC{1, 3} as a complementary SRS resource. The 6G UEs are configured to transmit SRS on the same frequency band and the same OS to the 5G UE, but are configured on a set of time-frequency resources including all three other SBs (starting with all the second, third and fourth SBs) which is complementary to the comb offset {1, 3} list.

In some embodiments, the BS always configures complementary information elements which are explicitly noted in a technical standard, for example, comb offset (or list), SB (or list), initial SB (or list), etc. Alternatively, in some embodiments, the BS distinguishes the complementary or direct configured information elements through the name of the information elements. In embodiments such as these, the BS can configure either a complementary or direct SRS resource configuration to the UE. Each information element is controlled separately.

For example, the BS can configure UE “comb-offset-complement” or “comb-offset-list-complement” to indicate the configured information element is for complementary resources configuration. In another example, the BS can configure UE “frequency-domain-position-complement” or “frequency-domain-position-list-complement” to indicate the configured information element is for complementary resources configuration.

In some embodiments, the BS can use an indicator for complementary configuration indication. For some related information elements, the BS can configure a complementary comb offset (or list), SB (or list), initial SB (or list), etc. in the SRS resource configuration for UE's operating according to a future RAT (e.g., 6G). The other related information elements, the BS directly configures to the UE.

In some embodiments, the BS can use a per information element indicator. In embodiments such as these, the BS distinguishes the complementary or directly configured information elements through an indicator within the configuration of the information elements. The BS indicate the information element either complementary or as a direct SRS resource configuration to the UE. Each information element is controlled separately. For example, the BS can configure UE “comb-offset” or “comb-offset-list” with an indicator of complementary SRS resource configuration. The status of the indicator can be 1) positive such as “on” or “true”; 2) negative such as “off” or “false”; or 3) absent. The meaning of each status can be standardized. For example, 1) positive can mean the information element is for complementary SRS resource configuration; both 2) negative and 3) absent can mean the information element is for not complementary SRS resource configuration.

In some embodiments, the BS can use one indicator per SRS resource configuration. In embodiments such as these, the BS distinguishes the complementary or directly configured information elements through an indicator commonly for the SRS resource configuration. The information elements that affect the indicator are standardized. For example, the BS can configure a common indicator of a complementary SRS resource configuration. The indicator commonly configures one or multiple information elements, for example which includes: “comb-offset”, “comb-offset-list”, “frequency-domain-position”, “frequency-domain-position-list”, etc., which all explicitly given in the standards. The status of the indicator can be 1) positive such as “on” or “true”; 2) negative such as “off” or “false”; 3) absent. The meaning of each status can be standardized, for example, 1) positive can mean the information elements are for complementary SRS resource configuration; both 2) negative and 3) absent can mean the information elements are not for complementary SRS resource configuration.

Although FIG. 16 illustrates one example complimentary time-frequency resource configuration in Part I signaling 1600, various changes may be made to FIG. 16. For example, various changes to the RATs could be made, the number of UEs could be different, etc. according to particular needs.

As noted above, Part II signaling controls the sub-sampling procedure of a set of time-frequency resources configured in Part I signaling.

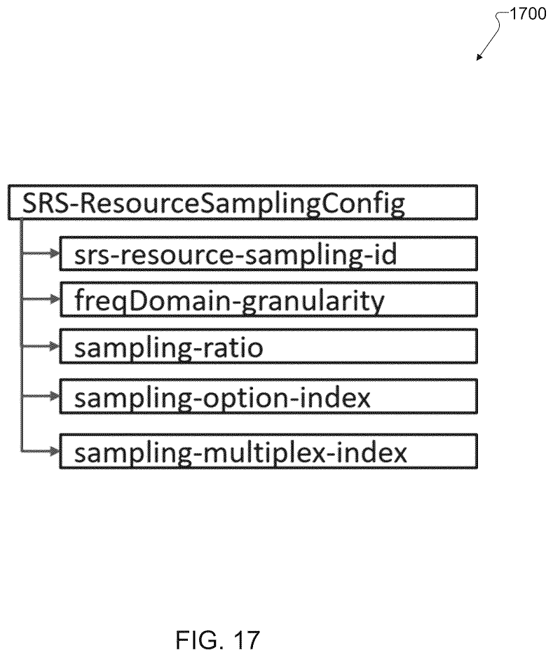

FIG. 17 illustrates an example Part II SRS resource sampling configuration 1700 according to embodiments of the present disclosure. The embodiment of a Part II SRS resource sampling configuration of FIG. 17 is for illustration only. Different embodiments of a Y could be used without departing from the scope of this disclosure.

In some embodiments, the BS configures the sub-sampling procedure through at least some of the information elements:
Index of time-frequency resource sampling configuration (srs-resource-sampling-id): to identify a specific time-frequency resource sampling configuration, for example.
Frequency domain granularity (freq-domain-granularityI): the minimum unit that the sub-sampling is processed. In an example, the option of the minimum unit is configured through an information element. freq-domain-granularity in FIG. 17 is configured as a choice of {re-level=num-re, rb-level=num-rb}. The choice of re-level and rb-level can be explicitly indicated in a technical standard and/or based on a UE reported capability.
Sub-sampling ratio (sub-sampling-ratio): the ratio that the minimum unit are sub-sampled. In an example, the sub-sampling ratio is configured through an information element. sub-sampling-ratio in FIG. 17 is configured with a specific value. The choice of sub-sampling-ratio can be explicitly indicated in a technical standard and/or based on a UE reported capability.
Sub-sampling approach and associated configuration (sub-sampling-approach): the sub-sampling approach can be, for example, uniform sampling, pseudo random permute based sampling, additive pseudo random sampling, etc. In some embodiments, the sub-sampling approach can explicitly indicated in a technical standard. In some embodiments, the sub-sampling approach can configuration through an information element in higher layer signaling. For example, sub-sampling-approach in in FIG. 17 is a configured choice of {uniform, pseudo-random, etc., . . . }. The sub-sampling approach can correspond to an approach-index as explicitly indicated in a technical standard.
Sub-sampling multiplex index (sampling-multiplex-index): the sub-sampling approach generates one or multiple sub-sampled SRS resources, for example, a 75% sub-sampling ratio of a uniform sampling results in four orthogonal SRS resources with different offset of the first minimum unit. Sub-sampling multiplex index, indicates which of the four orthogonal SRS resources is configured to the UE. For example, through an information element sampling-multiplex-index FIG. 17 configured with a choice of {0, . . . , M-1}, where M=1/sub-sampling-ratio.

Although FIG. 17 illustrates one example Part II SRS resource sampling configuration 1700, various changes may be made to FIG. 17. For example, various changes to information elements be made, etc., according to particular needs.

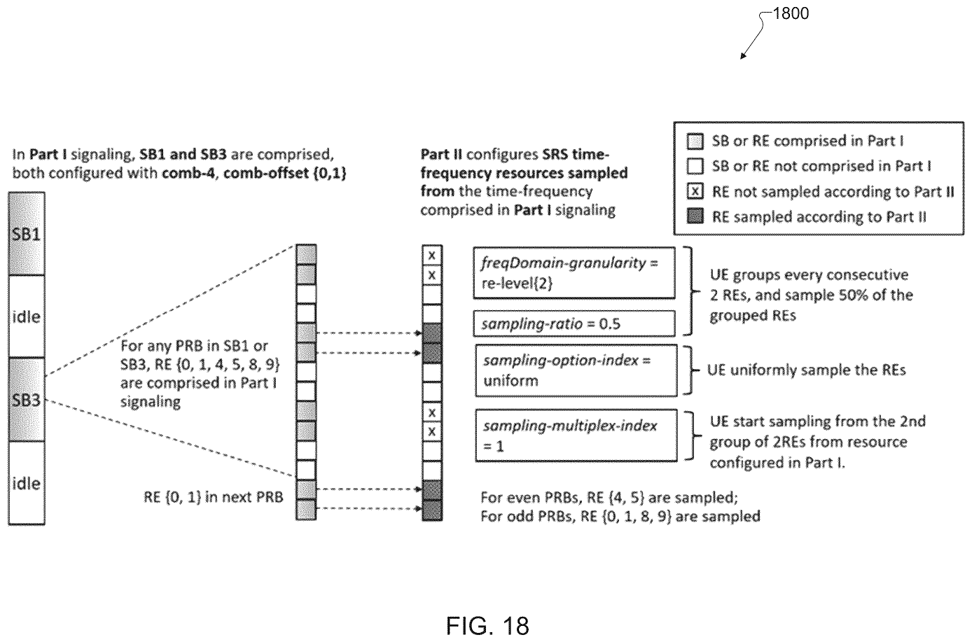

FIG. 18 illustrates an example of an SRS resource subsampling configured in Part II signaling and the time-frequency resource configured in Part I signaling 1800 according to embodiments of the present disclosure. The embodiment of resource configuration of FIG. 1800 is for illustration only. Different embodiments of an SRS resource subsampling configured in Part II signaling and the time-frequency resource configured in Part I signaling could be used without departing from the scope of this disclosure.

In the example of FIG. 18, a UE is configured with Part I signaling comprising SB 1 and SB 3 of a 4-band hopping. For each SB, comb-4 and comb-offset 0 and 1 are indicated. In Part II signaling:
The frequency domain granularity of the sampling is configured as re-level, and with 2 consecutive REs; the UE groups every 2 consecutive REs from the time-frequency resources configured in Part I signaling.
The sampling ratio is configured as 0.5; the UE samples 50% of the time-frequency resources configured in the Part I signaling.
The sub-sampling approach is configured as uniform; the UE samples the time-frequency resources configured in Part I signaling in a uniform manner.
The sub-sampling multiplex index is configured as 1; the UE starts to sample at the second group of 2 REs configured by Part I and Part II signaling in this example. The UE transmits SRS on the REs {4, 5} on even PRBs and REs {0, 1, 8, 9} on odd PRBs.

Although FIG. 18 illustrates one example of an SRS resource subsampling configured in Part II signaling and the time-frequency resource configured in Part I signaling, various changes may be made to FIG. 18. For example, various changes to subsampling could be made, etc., according to particular needs.

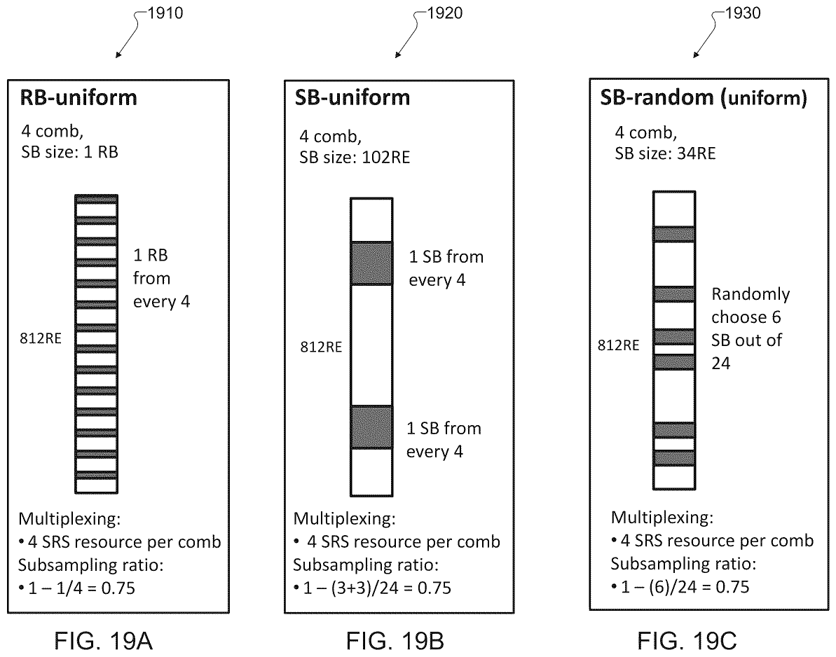

As noted above, in some embodiments, a BS may configure SRS subsampling for a UE so that the UE may generate a subsampled SRS signal according to an SRS subsampling pattern. In some embodiments, the subsampling patterns may be uniform or non-uniform as shown in FIGS. 19A-19F.

FIGS. 19A-19F illustrate example SRS subsampling patterns 1910-1960 according to embodiments of the present disclosure. The embodiments of SRS subsampling patterns of FIGS. 19A-19F are for illustration only. Different embodiments of SRS subsampling patterns could be used without departing from the scope of this disclosure.

In the example of FIG. 19A, the SRS resource is uniformly subsampled in the frequency domain according to an “RB-uniform” SRS subsampling pattern 1910. For SRS subsampling pattern 1910, in each RB, the RE density is determined by the comb size. The RBs are subsampled in a uniform manner for the SRS to be transmitted.

The example of FIG. 19A assumes that a BS has Nₜ antenna ports on a full-band of 100 MHz, yielding 272 RBs. With comb size 4, the full-band contains 812 REs. With a subsampling ratio of 75%, (i.e., 1 RB from every 4 RBs are sampled) Up to 4 orthogonal SRS resources are configurable, with subsampling starting from a 1^{st}, 2^{nd}, 3^{rd}, or 4^{th} subband. The BS can decompose each configured subband into 1 patch with 3 RE and Nₜ antenna ports, or a smaller patch size.

In the example of FIG. 19B, the SRS resource is uniformly subsampled in the frequency domain according to an “SB-uniform” SRS subsampling pattern 1920. For SRS subsampling pattern 1920, the full band is decomposed into multiple subbands. In each subband, the RE density is determined by the comb size. The subbands are subsampled in a uniform manner for the SRS to be transmitted. The subbands can be defined based on the number of RBs or REs.

The example of FIG. 19B assumes that a BS has Nₜ antenna ports on a full-band of 100 MHz, yielding 272 RBs. With comb size 4, the full-band contains 812 REs. With a subband size of 34 REs, the full-band includes 24 subbands. With a subsampling ratio of 75%, (i.e., 1 subband from every 4 subbands is sampled), up to 4 orthogonal SRS resources are configurable, with subsampling starting from a 1^{st}, 2^{nd}, 3^{rd}, or 4^{th} subband. The BS can decompose each configured subband into 1 patch with 34 RE and Nₜ antenna ports, or a smaller patch size.

In the example of FIG. 19C, the SRS resource is pseudo-randomly subsampled in the frequency domain according to an “SB-random (uniform)” SRS subsampling pattern 1930. For SRS subsampling pattern 1930, the full band is decomposed into multiple subbands. In each subband, the RE density is determined by the comb size. The selected subbands for SRS transmission are configured through a pseudo-random procedure known by both the BS and the UE. The probability of a subband being selected is uniform across the full-band, or in different frequency regions (groups of subbands) the number of randomly selected subbands are different. The subbands can be defined based on the number of RBs or REs.

The example of FIG. 19C assumes that a BS has Nₜ antenna ports on a full-band of 100 MHz, yielding 272 RBs. With comb size 4, the full-band contains 812 REs. With a subband size of 34 REs, the full-band includes 24 subbands. With a subsampling ratio of 75% (i.e., 6 subbands are selected randomly from the 24 subbands), up to 4 orthogonal SRS resources are configurable, for example, by randomly selecting 6 from the available subbands 3 times and marking the selected subbands as unavailable. The BS can decompose each configured subband into 1 patch with 34 REs and Nₜ antenna ports, or a smaller patch size.

In the example of FIG. 19D, the SRS resource is pseudo-randomly subsampled in the frequency domain according to an “SB-random (non-uniform)” SRS subsampling pattern 1940. For SRS subsampling pattern 1940, the selected subbands for SRS transmission are configured through a pseudo-random procedure known by both the BS and the UE. The probability density of a certain subband being selected is a variable across the full-band. The subbands can be defined based on the number of RBs or REs.

The example of FIG. 19D assumes that a BS has Nₜ antenna ports on a full-band of 100 MHz, yielding 272 RBs. With comb size 4, the full-band contains 812 REs. With a subband size of 34 REs, the full-band includes 24 subbands. With a subsampling ratio of 75%, 6 subbands are selected randomly from the 24 subbands. However, there are some groups of subbands that have a higher subsampling ratio. For example, the middle of the full-band has an 80% subsampling ratio. There are also some groups of subbands that have a lower subsampling ratio. For example, the edges of the full-band have a 50% subsampling ratio. The number of orthogonal SRS resources is up to 4 with a 75% overall subsampling ratio. However, this depends on the variable subband density configuration. In the example of FIG. 19D, only 2 orthogonal SRS resources can be configured. The BS can decompose each configured subband into 1 patch with 34 RE and Nₜ antenna ports, or a smaller patch size.

In the example of FIG. 19E, the SRS resource is uniformly subsampled in the frequency domain according to a “Large comb size” SRS subsampling pattern 1950. For SRS subsampling pattern 1950, the SRS subsampling is achieved by an enlarged comb size. For example, the comb size may be equal to {6, 8, 12, 16, 24, etc.}.

The example of FIG. 19E assumes that a BS has Nₜ antenna ports on a full-band of 100 MHz, yielding 272 RBs. With comb size 16, the full-band contains 203 REs. The BS can decompose each configured subband into 1 patch with 34 REs and Nₜ antenna ports as in other examples described herein, or any patch size depending on the implementation.

In the example of FIG. 19F, the SRS resource is subsampled in the frequency domain at the RE level according to an “RE-Random” SRS subsampling pattern 1960. For SRS subsampling pattern 1960, the selected subbands for SRS transmission are configured through a pseudo-random procedure known by both the BS and the UE. The probability of a subband being selected is uniform or a variable across the full-band.

The example of FIG. 19F assumes that a BS has Nₜ antenna ports on a full-band of 100 MHz, yielding 272 RBs. With comb size 4, the full-band contains 812 REs. With a subsampling ratio of 75% (i.e., 203 REs are selected randomly from the 812 REs), up to 4 orthogonal SRS resources are configurable, for example, by randomly selecting 203 REs from the available REs 3 times and marking the selected REs as unavailable. The BS can decompose each subsampled SRS resource into one or multiple overlapped patches depending on the implementation.

Although FIGS. 19A-19F illustrate some example SRS subsampling patterns 1910-1960, various changes may be made to FIGS. 19A-19F. For example, various changes to comb size, the subsampling ratio, the bandwidth, etc. could be made according to particular needs.

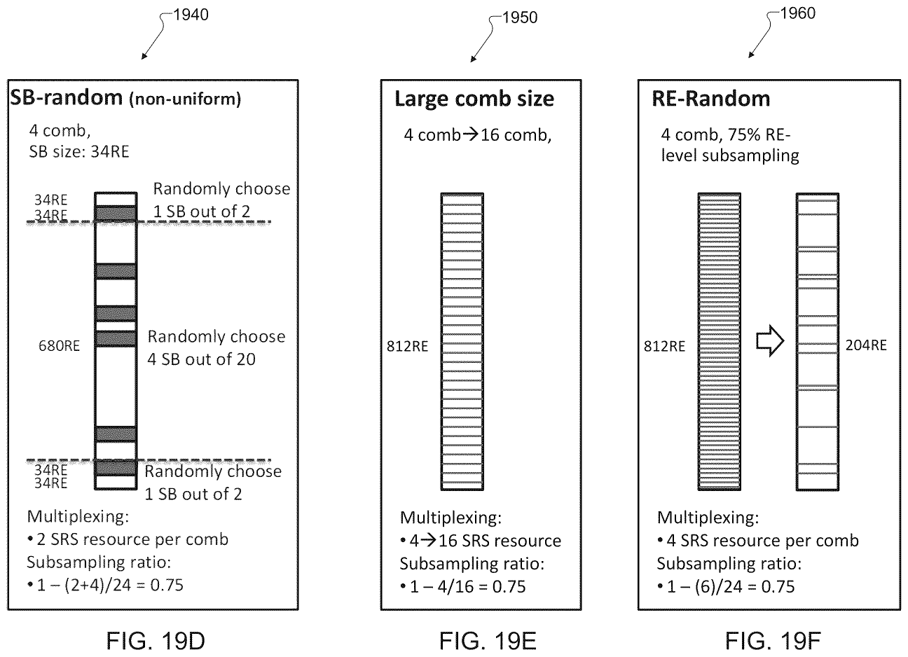

In some embodiments, the time-frequency resource configuration (in Part I) can include an index of a time-frequency resource sampling configuration (in Part II), similar as shown in FIG. 20.

FIG. 20 illustrates an example of a Part II configuration in each Part I configuration 2000 according to embodiments of the present disclosure. The embodiment of a Part II configuration in each Part I configuration of FIG. 20 is for illustration only. Different embodiments of a Part II configuration in each Part I configuration could be used without departing from the scope of this disclosure.

In the example of FIG. 20, the Part I configuration includes a Part II configuration index. The Part II configuration index identifies a Part II configuration for use in the two-part sparse SRS configuration signal.

Although FIG. 20 illustrates one example of a Part II configuration in each Part I configuration 2000, various changes may be made to FIG. 20. For example, various changes to the number of configurations in the index could be made, etc. according to particular needs.

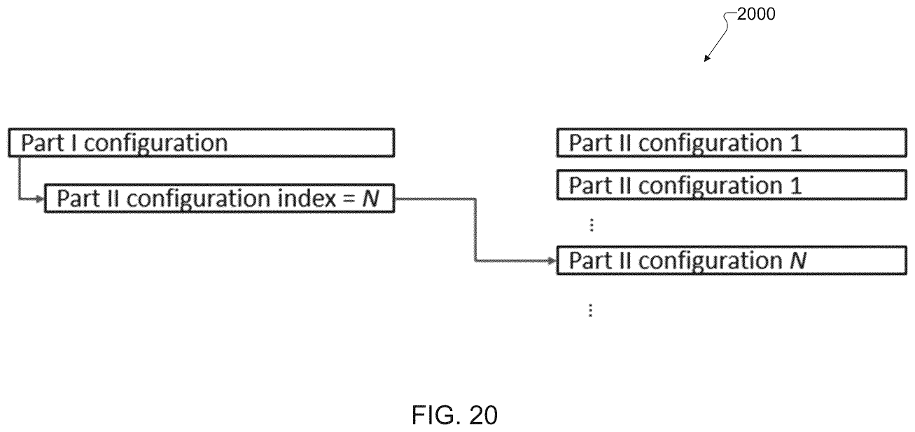

In some embodiments, the time-frequency resource configuration (in Part I) does not include an index of time-frequency resource sampling configuration (in Part II). In embodiments such as these, the paring of the time-frequency resource configuration and SRS time-frequency resource sampling configuration can be indicated in additional signaling, similar as shown in FIG. 21.

FIG. 21 illustrates example of coupling Part I and Part II configurations 2100 according to embodiments of the present disclosure. The embodiment of coupling Part I and Part II configurations of FIG. 21 is for illustration only. Different embodiments of coupling Part I and Part II configurations could be used without departing from the scope of this disclosure.

In FIG. 21, in a first example, (Example 1), Part I and Part II configurations are coupled through an additional RRC information element to be configured.

In another example (Example 2), Part I and Part II configurations are coupled through a MAC-CE, for example, in a TCI periodic or semi-persistent SRS configuration.

In yet another example, (Example 3), Part I and Part II configurations are coupled through a PDCCH, for example, via DCI aperiodic SRS triggering.

Although FIG. 21 illustrates one example of coupling Part I and Part II configurations 2100, various changes may be made to FIG. 21. For example, various changes to the types of signaling could be made, etc. according to particular needs.

In some embodiments, sparse non-uniform sampling, such as provided in a one-shot full-band sounding as described herein, may be used to generate full-band SRS, for example using SRS CSI inpainting.

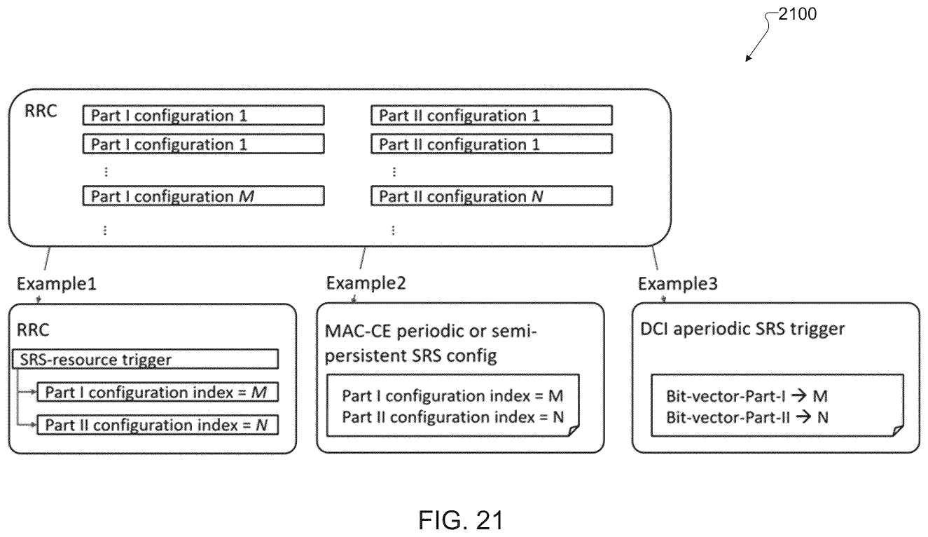

FIG. 22 illustrates an example AI-based SRS inpainting framework 2200 according to embodiments of the present disclosure. The embodiment of AI-based SRS inpainting of FIG. 22 is for illustration only. Different embodiments of AI-based SRS inpainting could be used without departing from the scope of this disclosure.

In the example of FIG. 22, a BS (such as gNB 102 of FIG. 1) configures frequency domain subsampled SRS resources 2205 for a UE (such as UE 116), for example, using two-part sparse SRS configuration signaling as described herein. After receiving the configuration, the UE transmits a subsampled SRS signal 2210 based on the configuration. The subsampled SRS signal 2210 has a reduced overhead and boosted per subcarrier power. After receiving the subsampled SRS signal 2210, the BS performs channel inpainting 2215 to recover SRS CSI of non-transmitted frequencies, resulting in inpainted SRS CSI 2220.

Although FIG. 22 illustrates one example AI-based SRS inpainting framework 2200, various changes may be made to FIG. 22. For example, various changes to the subsampling pattern could be made, etc. according to particular needs.

More detailed procedures for CSI inpainting may be found in U.S. application Ser. No. 19/232,842.

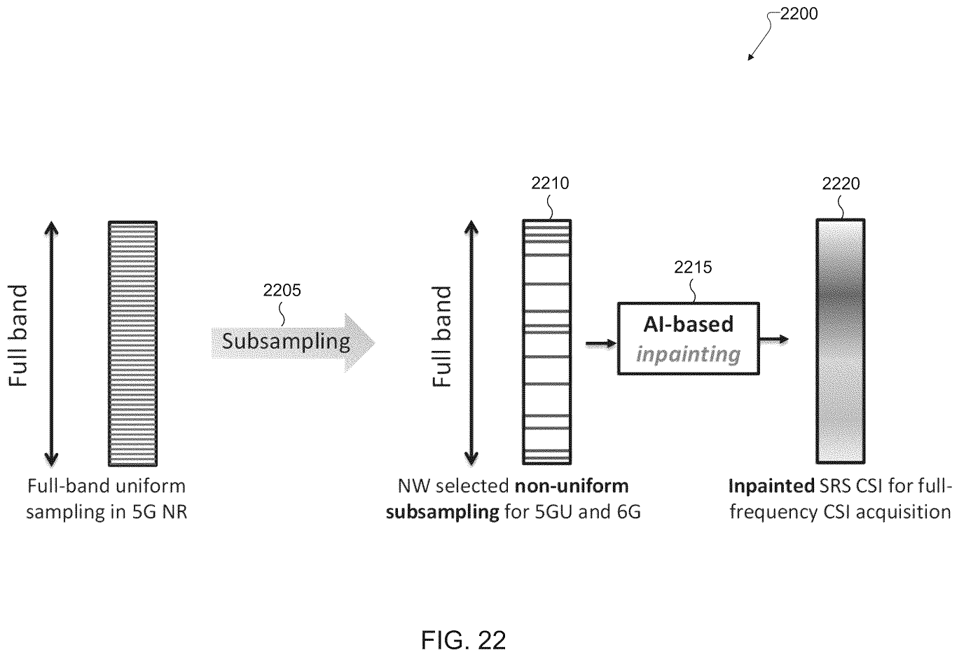

FIG. 23 illustrates an example method for two-part sparse SRS configuration signaling 2300 according to embodiments of the present disclosure. An embodiment of the method illustrated in FIG. 23 is for illustration only. One or more of the components illustrated in FIG. 23 may be implemented in specialized circuitry configured to perform the noted functions or one or more of the components may be implemented by one or more processors executing instructions to perform the noted functions. Other embodiments of a method for two-part sparse SRS configuration signaling could be used without departing from the scope of this disclosure.

In the example of FIG. 1, method 2300 begins at step 2310. At step 2310, a BS (for example, gNB 102 of FIG. 1) transmits first information indicating a SRS resource configuration for at least one UE (for example, UE 116 of FIG. 1) operating according to a first RAT. The SRS resource configuration allocates, to the at least one UE operating according to the first RAT, one or more SRS resources from an SRS resource set that are different from SRS resources from the SRS resource set allocated to at least one UE operating according to a second RAT. For example, the first RAT may be a future RAT (such as 6G), and the second RAT may be an existing RAT (such as 5G).

In some embodiments, the first information may be transmitted in signaling common for signaling an SRS resource configuration for the at least one UE operating according to the second RAT.

In some embodiments, the first information may indicate one of a list of SRS resources from the SRS resource set allocated to the at least one UE operating according to the first RAT, or a list of SRS resources from the SRS resource set allocated to the at least one UE operating according to the second RAT.

At step 2320, the BS transmits second information indicating an SRS resource sampling configuration for the at least one UE operating according to the first RAT.

In some embodiments, the BS may receive a one-shot (OS) full-band SRS that includes a subsampled SRS based on the first information and the second information transmitted by the at least one UE operating according to the first RAT, and an SRS transmitted by the at least one UE operating according to the second RAT multiplexed with the subsampled SRS transmitted by the at least one UE operating according to the first RAT.

In some embodiments, the SRS transmitted by the at least one UE operating according to the second RAT may be multiplexed with the subsampled SRS transmitted by the at least one UE operating according to the first RAT through one of different OFDM symbols, different frequency hops, combining frequency hopping bands, or combining resource elements.

In some embodiments, the BS may determine full band channel state information (CSI) from the OS full-band SRS via SRS CSI inpainting.

In some embodiments, the one or more SRS resources from the SRS resource set allocated to the at least one UE operating according to the first RAT may be orthogonal to the one or more SRS resources from the SRS resource set allocated to the at least one UE operating according to the second RAT.

Although FIG. 23 illustrates one example method for two-part sparse SRS configuration signaling 2300, various changes may be made to FIG. 23. For example, while shown as a series of steps, various steps in FIG. 23 could overlap, occur in parallel, occur in a different order, occur any number of times, be omitted, or replaced by other steps.

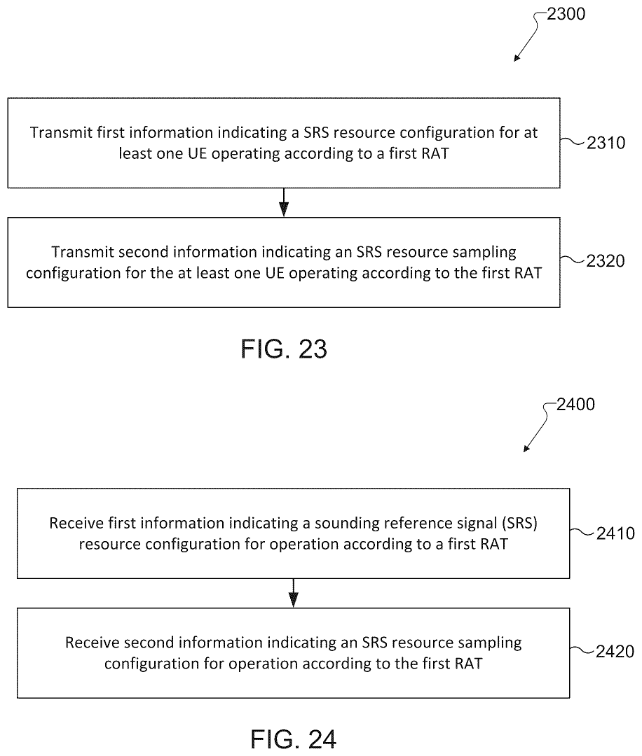

FIG. 24 illustrates another example method for two-part sparse SRS configuration signaling 2400 according to embodiments of the present disclosure. An embodiment of the method illustrated in FIG. 24 is for illustration only. One or more of the components illustrated in FIG. 24 may be implemented in specialized circuitry configured to perform the noted functions or one or more of the components may be implemented by one or more processors executing instructions to perform the noted functions. Other embodiments of a method for two-part sparse SRS configuration signaling could be used without departing from the scope of this disclosure.

In the example of FIG. 24, the method 2400 begins at step 2410. At step 2410, a UE (such as UE 116 of FIG. 1) receives first information indicating a SRS resource configuration for the UE operating according to a first RAT. The SRS resource configuration allocates, to the UE operating according to the first RAT, one or more SRS resources from an SRS resource set that are different from SRS resources from the SRS resource set allocated to at least one UE operating according to a second RAT. For example, the first RAT may be a future RAT (such as 6G), and the second RAT may be an existing RAT (such as 5G).

In some embodiments, the first information may be received in signaling common for signaling an SRS resource configuration for the at least one UE operating according to the second RAT.

In some embodiments, the first information may indicate one of a list of SRS resources from the SRS resource set allocated to the at least one UE operating according to the first RAT, or a list of SRS resources from the SRS resource set allocated to the at least one UE operating according to the second RAT.

At step 2420, the UE receives second information indicating an SRS resource sampling configuration for the UE operating according to the first RAT.

In some embodiments, the UE may transmit a portion of a one-shot (OS) full-band SRS that includes a subsampled SRS based on the first information and the second information transmitted by the UE operating according to the first RAT, and an SRS transmitted by the at least one UE operating according to the second RAT multiplexed with the subsampled SRS transmitted by the UE operating according to the first RAT.

In some embodiments, the SRS transmitted by the at least one UE operating according to the second RAT may be multiplexed with the subsampled SRS transmitted by the at least one UE operating according to the first RAT through one of different OFDM symbols, different frequency hops, combining frequency hopping bands, or combining resource elements.

In some embodiments, the one or more SRS resources from the SRS resource set allocated to the at least one UE operating according to the first RAT may be orthogonal to the one or more SRS resources from the SRS resource set allocated to the at least one UE operating according to the second RAT.

Although FIG. 24 illustrates one example method for two-part sparse SRS configuration signaling 2400, various changes may be made to FIG. 24. For example, while shown as a series of steps, various steps in FIG. 24 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A base station (BS) comprising:
a processor; and
a transceiver operably coupled to the transceiver, the transceiver configured to:
transmit first information indicating a sounding reference signal (SRS) resource configuration for at least one user equipment (UE) operating according to a first radio access technology (RAT); and
transmit second information indicating an SRS resource sampling configuration for the at least one UE operating according to the first RAT,
wherein the SRS resource configuration allocates, to the at least one UE operating according to the first RAT, one or more SRS resources from an SRS resource set that are different from SRS resources from the SRS resource set allocated to at least one UE operating according to a second RAT.

2. The BS of claim 1, wherein the first information is transmitted in signaling common for signaling an SRS resource configuration for the at least one UE operating according to the second RAT.

3. The BS of claim 1, wherein the first information indicates one of:
a list of SRS resources from the SRS resource set allocated to the at least one UE operating according to the first RAT; or
a list of SRS resources from the SRS resource set allocated to the at least one UE operating according to the second RAT.

4. The BS of claim 1, wherein the transceiver is further configured to receive a one-shot (OS) full-band SRS comprising:
a subsampled SRS based on the first information and the second information transmitted by the at least one UE operating according to the first RAT; and
an SRS transmitted by the at least one UE operating according to the second RAT multiplexed with the subsampled SRS transmitted by the at least one UE operating according to the first RAT.

5. The BS of claim 4, wherein the SRS transmitted by the at least one UE operating according to the second RAT is multiplexed with the subsampled SRS transmitted by the at least one UE operating according to the first RAT through one of:
different OFDM symbols;
different frequency hops;
combining frequency hopping bands; or
combining resource elements.

6. The BS of claim 4, wherein the processor is configured to determine full band channel state information (CSI) from the OS full-band SRS via SRS CSI inpainting.

7. The BS of claim 4, wherein the one or more SRS resources from the SRS resource set allocated to the at least one UE operating according to the first RAT are orthogonal to the one or more SRS resources from the SRS resource set allocated to the at least one UE operating according to the second RAT.

8. A user equipment (UE) comprising:
a processor; and
a transceiver operably coupled to the transceiver, the transceiver configured to:
receive first information indicating a sounding reference signal (SRS) resource configuration for the UE operating according to a first radio access technology (RAT); and
receive second information indicating an SRS resource sampling configuration for the UE operating according to the first RAT,
wherein the SRS resource configuration allocates, to the UE operating according to the first RAT, one or more SRS resources from an SRS resource set that are different from SRS resources from the SRS resource set allocated to at least one UE operating according to a second RAT.

9. The UE of claim 8, wherein the first information is received in signaling common for signaling an SRS resource configuration for the at least one UE operating according to the second RAT.

10. The UE of claim 8, wherein the first information indicates one of:
a list of SRS resources from the SRS resource set allocated to the UE operating according to the first RAT; or
a list of SRS resources from the SRS resource set allocated to the at least one UE operating according to the second RAT.

11. The UE of claim 8, wherein the transceiver is further configured to transmit a portion of one-shot (OS) full-band SRS comprising:
a subsampled SRS based on the first information and the second information transmitted by the UE operating according to the first RAT; and
an SRS transmitted by the at least one UE operating according to the second RAT multiplexed with the subsampled SRS transmitted by the UE operating according to the first RAT.

12. The UE of claim 11, wherein the SRS transmitted by the at least one UE operating according to the second RAT is multiplexed with the subsampled SRS transmitted by the UE operating according to the first RAT through one of:
different OFDM symbols;
different frequency hops;
combining frequency hopping bands; or
combining resource elements.

13. The UE of claim 11, wherein the one or more SRS resources from the SRS resource set allocated to the UE operating according to the first RAT are orthogonal to the one or more SRS resources from the SRS resource set allocated to the at least one UE operating according to the second RAT.

14. A method of operating a base station (BS), the method comprising:
transmitting first information indicating a sounding reference signal (SRS) resource configuration for at least one user equipment (UE) operating according to a first radio access technology (RAT); and
transmitting second information indicating an SRS resource sampling configuration for the at least one UE operating according to the first RAT,
wherein the SRS resource configuration allocates, to the at least one UE operating according to the first RAT, one or more SRS resources from an SRS resource set that are different from SRS resources from the SRS resource set allocated to at least one UE operating according to a second RAT.

15. The method of claim 14, wherein the first information is transmitted in signaling common for signaling an SRS resource configuration for the at least one UE operating according to the second RAT.

16. The method of claim 14, wherein the first information indicates one of:
a list of SRS resources from the SRS resource set allocated to the at least one UE operating according to the first RAT; or
a list of SRS resources from the SRS resource set allocated to the at least one UE operating according to the second RAT.

17. The method of claim 14, further comprising receiving a one-shot (OS) full-band SRS comprising:
a subsampled SRS based on the first information and the second information transmitted by the at least one UE operating according to the first RAT; and
an SRS transmitted by the at least one UE operating according to the second RAT multiplexed with the subsampled SRS transmitted by the at least one UE operating according to the first RAT.

18. The method of claim 17, wherein the SRS transmitted by the at least one UE operating according to the second RAT is multiplexed with the subsampled SRS transmitted by the at least one UE operating according to the first RAT through one of:
different OFDM symbols;
different frequency hops;
combining frequency hopping bands; or
combining resource elements.

19. The method of claim 17, further comprising determining full band channel state information (CSI) from the OS full-band SRS via SRS CSI inpainting.

20. The method of claim 17, wherein the one or more SRS resources from the SRS resource set allocated to the at least one UE operating according to the first RAT are orthogonal to the one or more SRS resources from the SRS resource set allocated to the at least one UE operating according to the second RAT.
